(19) United States
(12) Patent Application Publication
(10) Pub. No.: US 2026/0251342 A1
(43) Pub. Date: Aug. 27, 2026

(54) HEAT RECOVERY VENTILATION UNIT WITH DRAINAGE

(71) Applicant: ZEHNDER GROUP INTERNATIONAL AG, CH-57 GRÄNICHEN (CH)

(72) Inventors: Friso WIJNBERGEN, Zwolle (NL); Martijn HADDEMAN, Epe (NL)

(73) Assignee: ZEHNDER GROUP INTERNATIONAL AG, CH-57 GRÄNICHEN (CH)

(21) Appl. No.: 18/875,963

(22) PCT Filed: Jul. 4, 2023
(86) PCT No.: PCT/EP2023/068384

§ 371 Date: Dec. 17, 2024

(30) Foreign Application Priority Data
Jul. 15, 2022 (CH) CH000840/2022

(51) Int. Cl. F24F 13/22; F24F 12/00

(52) U.S. Cl. CPC F24F 13/222; F24F 12/006

(57) ABSTRACT

A heat recovery ventilation unit (1) with a fresh air flow drainage path and an exhaust air flow drainage path, each of which include a valve having a valve body and a valve seat, wherein each valve is configured such that the valve body is maintained in a closed position in the valve seat at least partially due to the negative pressure provided by a ventilation assembly (6) of the heat recovery ventilation unit (1).

### BACKGROUND OF THE INVENTION

### Field of the Invention

The present invention lies in the technical field of building ventilation and relates to a heat recovery ventilation unit and the use of such a heat recovery ventilation unit.

### Discussion of Related Art

Heat recovery ventilation units comprise a heat exchanger and typically define two separate air flow paths, one for the incoming fresh air, entering the building and one for the expelled exhaust air exiting the building. These two flow paths are both guided through the heat exchanger in order to enable heat exchange between them. For example, during colder months, thermal energy from the exhaust air can be transmitted to the incoming cold fresh air. Thereby, the temperature of the incoming air is increased and energy consumption for additional building heating systems, such as radiators can be decreased.

A problem associated with such units is that if the warmer air stream is saturated with a vaporized liquid, condensation occurs upon heat exchange with the colder air stream, which leads to the accumulation of condensate inside the unit, which must be removed from the unit. Common heat recovery ventilation units therefore use drip trays and corresponding drainage outlets for this purpose. Originally, units often contained two air flow paths with different configurations, e.g. units which comprise only a single drainage flow path being in fluidic communication with the one of the of air flow paths, such as the exhaust air flow path. Such units suffer from cumbersome usability, as special care must be taken during installation that the correct air flow paths are connected to the desired tubing inside the building to ensure that the exhaust air carrying the vaporized liquid is in fluid connection with the drainage flow path. To solve this problem, units have been developed which are as such, i.e. wholly, essentially symmetric. In particular, such symmetric units are equipped with one drainage flow path per air flow path, i.e. a drainage flow path being in fluidic communication with the exhaust air flow path and another drainage flow path being in fluidic communication with the exhaust air flow path. During installation, the user can select which one of the two drainage flow paths shall actually be active and open towards a common drainage outlet. Such a unit is for example disclosed in international patent application WO 2022/018021 A1 of the applicant, which is incorporated herein by reference in its entirety.

A problem with such units is still that the user must actively select which of the flow paths is active and can be used to expel liquid from the unit and must therefore also manipulate the device accordingly, at least during its installation by connecting the correct drainage flow path with the drainage outlet.

Furthermore, to avoid malfunction or unwanted odor exposure, it is desirable that the one or both air flow paths and/or the one or both drainage paths are not continuously open to the environment, but only expel accumulated liquid at specific intervals.

### SUMMARY OF THE INVENTION

It is therefore the general object of the present invention to advance the state of the art regarding heat recovery ventilation units and preferably to overcome the disadvantages of the prior art fully or partly. In advantageous embodiments, a heat recovery ventilation unit is provided which is easier to install and which can preferably be used in both configurations without additional manipulations. Thus, the invention preferably provides a heat recovery ventilation unit for which it is irrelevant which air flow path is used as the exhaust air flow path and which is used as the fresh air flow path, as both air flow paths can be used for this purpose without additional modification, such as connecting a drainage flow path with a common drainage outlet. In further advantageous embodiments, a heat recovery ventilation unit is provided which allows for an accurate control of liquid release. In other advantageous embodiments, a heat recovery ventilation unit is provided which is easier to manufacture.

The general object is achieved by the subject-matter of the independent claims. Further advantageous embodiments follow from the dependent claims as well as the overall disclosure.

A first aspect of the invention relates to a heat recovery ventilation unit which comprises a unit housing. The unit housing defines a unit compartment. It may for example be possible that some, the majority or even all of the components of the heat recovery ventilation unit are arranged inside the unit compartment. However, it is also possible that certain components or parts of certain components are arranged outside the unit compartment. The heat recovery ventilation unit further comprises a fresh air flow path and an exhaust air flow path, which are in heat exchange contact with each other. For example, both, the fresh air flow path and the exhaust air flow path can extend through a heat exchanger, such as a plate heat exchanger, which may in this or any other embodiment be comprised by the heat recovery ventilation unit. Typically, the fresh air flow path and the exhaust air flow path can be fluidic separate from each other. Furthermore, the heat recovery ventilation unit comprises a ventilation assembly, which is configured such that it can provide a negative pressure within the unit compartment. A negative pressure as used herein is a pressure which is typically below the pressure outside the heat recovery ventilation unit, i.e. in the outside environment of the heat recovery ventilation unit. For example, the negative pressure may be below 1 atm. Furthermore, the heat recovery ventilation unit comprises a fresh air flow drainage path which is configured for collecting and discharging liquid from the fresh air flow path. Additionally, the heat recovery ventilation unit comprises an exhaust air flow drainage path, which is configured for collecting and discharging liquid from the exhaust air flow path. The exhaust air flow drainage path is typically separate from the fresh air flow drainage path, however, they may meet each other at the common drainage outlet. The fresh air flow drainage path and the exhaust air flow drainage path are both fluidic connected to a single common drainage outlet. Furthermore, each one of the fresh air flow drainage path and the exhaust air flow drainage path comprises a valve having a valve body and a valve seat. This means, the fresh air flow drainage path has a fresh air flow drainage valve and the exhaust air flow drainage path has a therefrom separate exhaust air flow drainage valve. Each one of the two valves is preferably configured, i.e. arranged, such that the valve body of the corresponding valve is maintained in a closed position in its corresponding valve seat at least partially or also completely, due to the negative pressure in the unit compartment provided by the ventilation assembly. This means that each valve is preferably configured such that its valve body is pulled or sucked against its valve seat by the negative pressure when the ventilation assembly provides the negative pressure within the unit compartment. Thereby it is ensured that the valves are maintained in their closed position until either the provision of the negative pressure ceases or until another force, i.e. a counter force, acting on the valve body, overcomes the force exerted by the negative pressure. Thereby, better control and more reliable sealing is provided.

In some embodiments each one of the two valves is preferably configured such that a force vector exerted by the negative pressure in the unit compartment by the ventilation assembly acting on the valve body is directed towards and/or in the direction of the valve seat.

It is understood that the term “fluidic connected” preferably also includes air flow paths which can be temporarily closed if the corresponding valve is in the closed position but can be open if the valve is in the open position.

In some embodiments, each valve body is arranged downstream of the valve seat, i.e. downstream of its corresponding valve seat. This means that the valve body and the valve seat are arranged such that liquid flowing from the fresh air flow path to the common drainage outlet first passes through the valve seat, before it passes the valve body of this valve. Accordingly, the valve body and the valve seat are arranged such that liquid flowing from the exhaust air flow path to the common drainage outlet first passes through the valve seat, before it passes the valve body of this valve. The term “downstream” refers to the flow direction of the liquid towards the common drainage outlet.

In some embodiments, each valve seat and the common drainage outlet are arranged such that liquid which passes the corresponding valve and the valve seat flows due to the gravitational force to the common drainage outlet. Therefore, fluid leaving the corresponding valve and flowing to the common drainage outlet does preferably not have to flow against the gravitational force.

In some embodiments, each of the two valve seats of the two valves is arranged on the same level or offset in a first direction, e.g. the vertical direction, with respect to the common drainage outlet. It is understood that the two valve seats are typically aligned with each other, i.e. on the same level and not offset to each other. Typically, the exhaust air flow drainage path and the fresh air flow drainage path are configured such that liquid flowing towards and then through the valve towards the common drainage outlet, approaches the valve seat also along this first direction, or along a linear path being defined by the aligned two valve seats and the common drainage outlet, but usually not against the first direction.

In some embodiments, the fresh air flow drainage path, the exhaust air flow drainage path and the common drainage outlet may all be fully or at least partly arranged outside of the unit compartment. This may also be the case for a drainage assembly as disclosed herein below.

It is understood that in the closed position of any of the valves, liquid can essentially not, e.g. not, pass the corresponding valve. In contrast, in an open position, liquid can pass the corresponding valve. Each valve is typically arranged within its corresponding air flow drainage path, i.e. the fresh air flow drainage valve is arranged inside the fresh air flow drainage path and the exhaust air flow drainage valve is arranged inside the exhaust air flow drainage path. Each valve can be switched between its closed position and at least one open position.

It is further understood that if a valve is discussed herein, the disclosure typically relates to each of the two valves, i.e. to the fresh air flow drainage valve and also to the exhaust air flow drainage valve unless noted otherwise.

Furthermore, it is clear to the skilled person that the valve seat defines a fluid opening via which fluid can flow in the open position of the valve body through the valve and which can be completely closed by the corresponding valve body of the valve. Typically, the valve body and the valve seat have corresponding shapes, i.e. they have shapes which are designed such that they can provide a fluid tight, in particular liquid tight connection, in the closed position.

In some embodiments, the valve seat may be arranged between the corresponding valve body and the unit compartment within which the ventilation assembly provides a negative pressure.

In some embodiments, the ventilation assembly comprises a fan unit, such as a scroll fan unit. Preferably, the ventilation assembly comprises two fan units, wherein one fan unit is arranged inside the fresh air flow path, respectively is associated therewith, and the other fan unit is arranged inside the exhaust air flow path, respectively is associated therewith. The ventilation assembly, and particularly the two fan units, is/are typically arranged downstream of the heat exchanger. The ventilation assembly generates a negative pressure, thereby fresh air is sucked into the heat recovery ventilation unit from the outside environment via a fresh air inlet of the heat recovery ventilation unit and the used exhaust air is sucked from the building into the heat recovery ventilation unit via an exhaust air inlet of the heat recovery ventilation unit. Furthermore, the ventilation assembly is generally configured such that the incoming fresh air is then expelled into the building via a fresh air outlet of the heat exchanger recovery unit and the used air is expelled to the outside environment of the heat recovery ventilation unit via a corresponding exhaust air outlet of the heat recovery ventilation unit. It is understood that the fresh air flow path generally extends between the fresh air outlet and the fresh air inlet and that the exhaust air flow path generally extends between the exhaust air outlet and the exhaust air inlet.

In some embodiments, the valve, and in particular the valve body, is configured such that the valve body is further, i.e. additionally to the negative pressure exerted by the ventilation assembly, maintained in the closed position in the valve seat by the gravitational force acting on the valve body.

The force vectors of the force originating from the negative pressure provided by the ventilation assembly acting on the valve body and of the gravitational force acting on the ball valve which both maintain the valve body in the closed position, may in some embodiments, in particular in the mounted state in which the heat recovery ventilation unit is mounted to a wall, floor or ceiling, be arranged to each other in an angle of between 0° (i.e. being parallel to each other) and 90°, preferably the angle is 0° to 10°, more preferably 0°. In these embodiments, controlling the valve is improved.

In some embodiments, the valve, and in particular the valve body, is configured such that the valve, e.g. the valve body, is switched from the closed position into an open position if a liquid force, in particular the weight of the liquid, being exerted by a liquid, which is present within the fresh air flow drainage path or within the exhaust air flow drainage path, onto the corresponding valve body of the fresh air flow drainage valve or the exhaust air flow drainage valve exceeds a maintaining force. This maintaining force originates from the negative pressure provided by the ventilation assembly and optionally also from the gravitational force which may act on the valve body and which may maintain the corresponding valve body in the closed position in its valve seat. The maintaining force F_{M} may therefore in some embodiments be equal to the force F_{P} acting on the valve body due to the negative pressure or it may in some embodiments be defined as the sum of force F_{P} and the gravitational force F_{G}. In certain embodiments, the maintaining force F_{M} may be the sum of F_{P}, F_{G} and additionally the frictional force F_{F} between the valve body and the valve seat. However, the frictional force may in certain embodiments be negligible. The valve and in particular the valve body, is configured such that the valve, e.g. the valve body, is switched from the closed position into an open position if the liquid force, e.g. the weight of the liquid, F_{L} which acts on the valve body is larger than F_{M}. It is clear that the liquid referred to hereinabove is arranged inside the fresh air flow drainage path or inside the exhaust air flow drainage path and particularly upstream of the corresponding valve of the fresh air flow drainage path or within the exhaust air flow drainage path. The liquid may therefore be collected directly upstream of the valve and accumulate. Once the liquid reaches a threshold amount (i.e. mass), F_{L} becomes larger than F_{M} and the valve body switches from the closed position into an open position in which the liquid flows through the valve and from there to the common drainage outlet via which it is expelled from the heat recovery ventilation unit. Once the mass of the liquid falls below the threshold amount (i.e. mass), F_{L} becomes smaller than F_{M} and the valve switches back from the open position into the closed position.

The liquid force typically originates, preferably fully originates, from the weight force of the liquid. The valve body is therefore preferably not switched from the closed position into the open position only because of a buoyant force forcing the valve body to float away from the valve seat, but because the liquid force, i.e. the weight force exerted by the liquid pushes the valve body away from the valve seat.

In some embodiments, the valve, and particularly the valve body, is configured such that the valve, e.g. the valve body, is switched from the open position into the closed position if the liquid force F_{L} being exerted by liquid within the fresh air flow drainage path or the exhaust air flow drainage path onto the corresponding valve body falls below the maintaining force F_{M}.

Typically, switching the valve body between the open position and the closed position comprises moving the valve body with respect to its valve seat. In certain embodiments, only the corresponding valve body is moved.

In some embodiments, each valve is a ball valve, i.e. each valve comprises a valve ball as the valve body and a corresponding valve seat.

In some embodiments, each valve, particularly each ball valve, comprises, respectively defines, a ball accommodation chamber. This ball accommodation chamber is in these embodiments configured and/or designed such that the valve ball is maintained, particularly always maintained, within the ball accommodation chamber. Furthermore, the ball accommodation chamber is in these embodiments configured and/or designed such that the valve ball can be moved inside the ball accommodation chamber upon which the valve can be switched between the open position and the closed position. For example, the valve, e.g. the ball valve, may comprise chamber walls which delimit, respectively define, the ball accommodation chamber. The valve ball may be surrounded by these chamber walls. Furthermore, the chamber walls may delimit, respectively define, the chamber fluid inlet and the chamber fluid outlet as described herein below.

In some embodiments, each ball accommodation chamber has a volume which is at least 1.2-times, particularly 1.5-times, more particularly 2-times, larger than the volume of the corresponding valve ball, i.e. the valve ball which is arranged inside the ball accommodation chamber.

In some embodiments, each ball accommodation chamber has a volume which is at most 5-times, particularly 3-times, more particularly 2-times, larger than the volume of the corresponding valve ball, i.e. the valve ball which is arranged inside the ball accommodation chamber.

In certain embodiments, each ball accommodation chamber has a volume which is 1.2-times to 5-times, particularly 1.2-times to 3-times, more particularly 1.2 times to 2-times, larger than the volume of the corresponding valve ball, i.e. the valve ball which is arranged inside the ball accommodation chamber.

In some embodiments, each one of the two ball accommodation chambers comprises a chamber fluid inlet. The chamber fluid inlet is defined, respectively delimited by the valve seat. It is understood that if the ball accommodation chambers are each delimited by for example chamber walls, the valve seat may for example be a part of such a chamber wall. Furthermore, each one of the two ball accommodation chambers comprises a chamber fluid outlet. The chamber fluid inlet and the chamber fluid outlet allow in the open position of the valve that liquid can flow through the ball accommodation chamber via the chamber fluid inlet and the chamber fluid outlet. In the closed position, at least one, or even both, of the chamber fluid inlet and the chamber fluid outlet is fluidic closed, in particular at least such that it does not allow flow of liquid there through. As the skilled person understands, in such a closed position, the valve ball may occlude at least one, or even both, of the chamber fluid inlet and the chamber fluid outlet. Furthermore, in the open position, both the chamber fluid outlet and the chamber fluid inlet are fluidic open, e.g. at least such that they allow that liquid flows through them. Therefore, the valve, and in particular the valve ball and the ball accommodation chamber, are preferably in this or any other embodiment as described herein, configured such that the valve ball can be moved in the ball accommodation chamber between the closed position and the open position such that in the closed position at least one or both of the chamber fluid inlet and the chamber fluid outlet is occluded by the valve ball thereby preventing the flow of liquid there through and in the open position the valve ball does not occlude any of chamber fluid inlet and the chamber fluid outlet, thereby allowing the flow of liquid there through.

In some embodiments, each valve is a flap valve, which comprises a flap. It should be noted that it is also possible that the two valves are of different types. For example, one of the valves may be a ball valve according to any of the embodiments as described herein, and one valve may be a flap valve. Alternatively, both valves may be a flap valve or both valves may be a ball valve.

In typical embodiments, the heat recovery ventilation unit only comprises two of the valves as described in any of the embodiments herein.

A flap valve comprises a valve seat and a corresponding flap. The flap and the valve seat are typically configured such that the flap can in the closed position of the valve fully close, respectively occlude, an opening defined by the valve seat. In order to switch the valve between the open position and the closed position, the flap or at least a portion of it, is movable with respect to the valve seat. Thus, in the open position, the opening defined by the valve seat may be uncovered by the flap and therefore allow liquid to flow there through.

In some embodiments, the flap valve is configured such that it can be switched from the closed position into the open position either by pivoting the whole flap with respect to the valve seat or by bending or pivoting only a portion of the flap with respect to the valve seat and/or with respect to the remaining part of the flap.

In some embodiments, the fresh air flow drainage path and the exhaust air flow drainage path are symmetric to each other. Particularly, the fresh air flow drainage path and the exhaust air flow drainage path are symmetric to each other with respect to a symmetry plane, which may for example extend through the common drainage outlet.

In some embodiments, the recovery unit comprises a drainage assembly housing. Such a drainage assembly housing may comprise, respectively define the fresh air flow drainage path, and particularly also the valve being comprised by the fresh air flow drainage path. Furthermore, the drainage assembly housing may comprise, respectively define, the exhaust air flow drainage path, and particularly also the valve being comprised by the exhaust air flow drainage path. Furthermore, the drainage assembly housing may comprise, respectively define, the common drainage outlet.

In certain embodiments, the drainage assembly housing is injection molded. For example, the drainage assembly housing may be injection molded as a single piece or as multiple pieces being joined together.

In some embodiments, the drainage assembly housing defines a fresh air flow drainage path inlet and an exhaust air flow drainage path inlet, which are both offset with respect to the common drainage outlet. It is understood that the fresh air flow drainage path inlet allows access to the fresh air flow drainage path and that the exhaust air flow drainage path inlet allows access to the exhaust air flow drainage path. Typically, the valve of the fresh air flow drainage path, i.e. the fresh air flow drainage valve, is arranged between the common drainage outlet and the fresh air flow drainage path inlet. Accordingly, the valve of the exhaust air flow drainage path, i.e. the exhaust air flow drainage valve, is typically arranged between the common drainage outlet and the exhaust air flow drainage path inlet.

In certain embodiments, the fresh air flow drainage path inlet and the exhaust air flow drainage path inlet are arranged on the same level, e.g. the same vertical level. That is, the fresh air flow drainage path inlet and the exhaust air flow drainage path inlet are aligned with each other. In contrast, the common drainage outlet is arranged offset to the fresh air flow drainage path inlet and the exhaust air flow drainage path inlet, in particular in a first direction, e.g. vertically offset.

In some embodiments, the fresh air flow drainage path and the exhaust air flow drainage path and the common drainage outlet are arranged such that liquid can flow between each of the valves (i.e. after having passed the valve) to the common drainage outlet without more than 1 directional changes, in particular without any directional changes.

In some embodiments, the fresh air flow drainage path and the exhaust air flow drainage path and the common drainage outlet are arranged such that liquid can flow between each of the valves (i.e. after having passed the valve) to the common drainage outlet such that it does not have to flow against the gravitational force.

In some embodiments, the valve body and/or the valve seat are made of a polymer material, in particular an elastomer. The polymer material of the valve body and the polymer material of the valve seat may be the same or different. Elastomeric materials are preferred as they typically provide a better sealing and further improve the frictional lock between the valve seat and the valve body.

In some embodiments, the drainage assembly and/or the drainage assembly housing may be releasably connected to the remaining parts of the heat recovery ventilation unit. A releasable connection as used herein is a connection which can multiple times be disconnected and multiple times be reconnected without essentially destroying the structural integrity of the connected elements. For example, a releasable connection may be a form-locking and/or force-locking connection, such as a snap fit connection, a bayonet type connection, or the like. The drainage assembly and/or the drainage assembly housing may for example be connected to corresponding connection ports defined by the unit housing of the heat recovery ventilation unit, which open towards, e.g. provide access to, the unit compartment. Therefore, in some embodiments, the drainage assembly and/or the drainage assembly housing is not arranged inside the unit compartment. Thus, in such embodiments also the fresh air flow drainage path, the exhaust air flow drainage path and the common drainage outlet, as well as the corresponding two valves are not arranged inside the unit compartment.

A second aspect of the invention relates to the use of a heat recovery ventilation unit according to any of the embodiments as described herein, in particular with respect to the first aspect of the invention, in a building. The use may also be a method for ventilating a building, comprising the operation of a heat recovery ventilation unit according to any of the embodiments as described herein.

A third aspect of the invention relates to a building comprising a heat recovery ventilation unit according to any of the embodiments as described herein, in particular with respect to the first aspect of the invention. In some embodiments, the heat recovery ventilation unit is mounted to a wall, a ceiling or a floor of the building, particularly such that the common drainage outlet is arranged in such a manner that any liquid can flow by gravitational force, in particular only by gravitational force, from each of the valves of the fresh air flow drainage path or the exhaust air flow drainage path to the common drainage outlet, preferably directly to the common drainage outlet. This means, the liquid does not have to flow against the gravitational force between each of the valves and the common drainage outlet.

In embodiments in which the valves are ball valves, the heat recovery ventilation unit may be mounted to the wall, ceiling or floor of the building, such that liquid flowing from the valve raises the valve ball against the gravitational force, i.e. the liquid flows from, and approaches the valve from below the valve body and/or from below the valve seat, through the valve. Preferably, the valve is arranged such that the liquid first flows to and/or through the valve seat, before it comes into contact with the valve body, i.e. the valve body is arranged downstream of the valve seat.

A fourth aspect of the invention relates to a drainage assembly, in particular the drainage assembly as described herein, in particular with respect to the first aspect of the invention. The drainage assembly comprises a drainage assembly housing which comprises, respectively defines, a fresh air flow drainage path and an exhaust air flow drainage path as well as a common drainage outlet. The fresh air flow drainage path and the exhaust air flow drainage path are fluidic connected to the common drainage outlet. Each of the fresh air flow drainage path and the exhaust air flow drainage path comprises a valve which has a valve body and a valve seat. Furthermore, the drainage assembly housing defines a fresh air flow drainage path inlet and an exhaust air flow drainage path inlet. It is understood that the valve of the fresh air flow drainage path is arranged between the fresh air flow drainage path inlet and the common drainage outlet and that the valve of the exhaust air flow drainage path is arranged between the exhaust air flow drainage path inlet and the common drainage outlet. Furthermore, each valve body is arranged downstream of the corresponding valve body of its valve and upstream of the common drainage outlet, i.e. it is arranged between the valve seat of the corresponding valve and the common drainage outlet. Furthermore, it is understood that the valve may be a valve as described in any of the embodiments herein, in particular with respect to the first aspect of the invention.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims.

FIG. 1 shows a heat recovery ventilation unit according to an embodiment of the invention;

FIG. 2 shows the heat recovery ventilation unit of FIG. 1 wherein parts of the housing are removed;

FIG. 3 shows a detailed perspective front side view of a drainage assembly as it can be used in some embodiments of the invention;

FIG. 4 shows a detailed perspective backside view of the drainage assembly of FIG. 3;

FIG. 5 shows a sectional view of a drainage assembly as it can be used in some embodiments of the invention, wherein both valve bodies are in the closed position;

FIG. 6 shows a sectional view of the drainage assembly of FIG. 5 wherein one of the two valve bodies is in the open position;

FIG. 7 shows a sectional view of another drainage assembly as it can be used in some embodiments of the invention, wherein both valve bodies are in the closed position; and

FIG. 8 shows a sectional view of another drainage assembly as it can be used in some embodiments of the invention, wherein one of the valve bodies is in the open position.

### DETAILED DESCRIPTION OF THE INVENTION

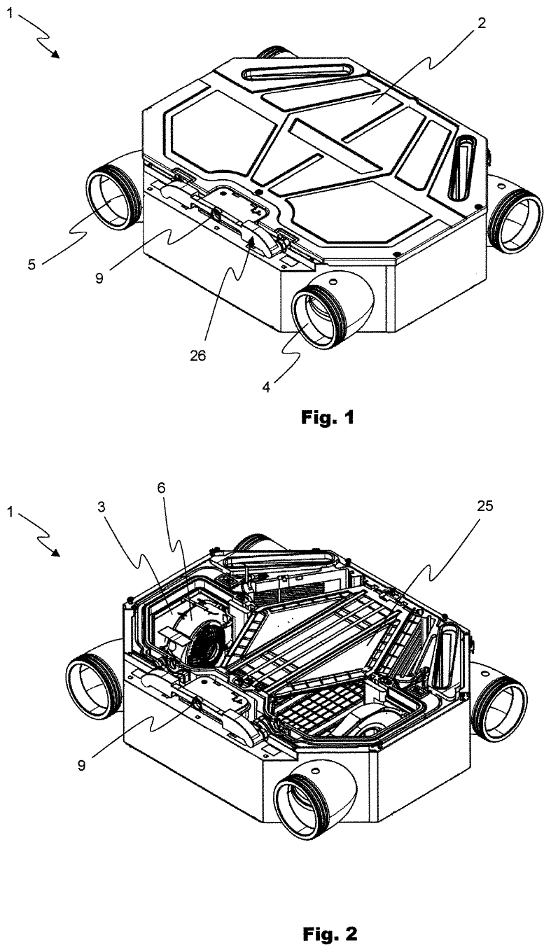

FIGS. 1 and 2 show a heat recovery ventilation unit 1. For illustrating the inside of the heat recovery ventilation unit 1 the upper side of unit housing 2 in FIG. 1 is removed in FIG. 2. It should be noted that the heat recovery unit is shown with its bottom side up, i.e. if the unit would be mounted to a ceiling it would be turned by 180° such that the flat upper part of the unit housing faces the floor.

Heat recovery ventilation unit 1 comprises unit housing 2, which defines, respectively delimits unit compartment 3. Arranged inside unit compartment 3 is ventilation assembly 6, which in this embodiment consists of two fan units which are scroll fan units. One fan unit is arranged within fresh air flow path 4 which extends from a fresh air inlet through unit compartment 3 to a fresh air outlet and the other fan unit is arranged within exhaust air flow path 5 which also extends through unit compartment 3 from an exhaust air outlet to an exhaust air inlet.

Furthermore, in this or any other embodiments as described herein, the heat recovery ventilation unit 1 may comprise a heat exchanger 25, such as a plate heat exchanger, being preferably also arranged inside unit compartment 3. The exhaust air flow path and the fresh air flow path are in heat exchange to each other, particularly via heat exchanger 25, i.e. they are configured such that they can exchange thermal energy with each other.

Additionally, common drainage outlet 9 of a drainage assembly 26 is visible. As can be seen, drainage assembly 26, which may in this or any other embodiment as described herein, comprise a fresh air flow drainage path being in fluidic communication with fresh air flow path 4 and an exhaust air flow drainage path being in fluidic communication with exhaust air flow path 5. Both, the fresh air flow drainage path and the exhaust air flow drainage path are fluidic connected to this common drainage outlet 9, through which accumulated and undesired fluid can be expelled from heat recovery ventilation unit 1.

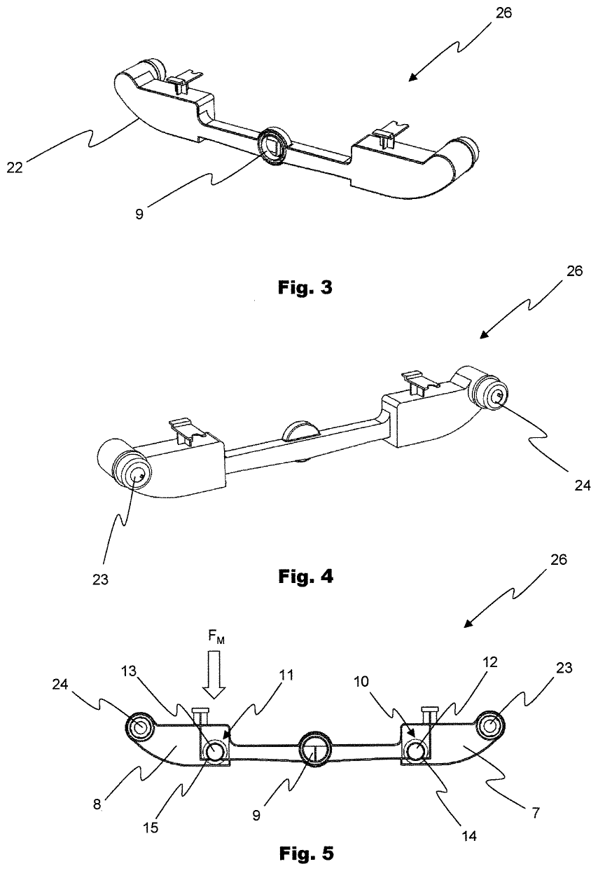

FIGS. 3 to 6 show detailed views of a drainage assembly 26, which may be used in a heat recovery ventilation unit 1 shown in FIGS. 1 and 2. As can be seen from FIG. 5, the flow path on the right side of common drainage outlet 9 is fresh air flow drainage path 7 and accordingly, on the left side of common drainage outlet 9 is exhaust air flow drainage path 8. Each one of the fresh air flow drainage path 7 and exhaust air flow drainage path 8 comprises a valve, i.e. valve 10 within fresh air flow drainage path 7 and valve 11 within exhaust air flow drainage path 8. Each one of these valves comprises a valve body 12 and 13 as well as a corresponding valve seat 14 and 15. In general, it is preferred that the valve body 12 and 13 of each valve is arranged downstream of the valve seat 14 and 15 of the corresponding valve 10 and 11 as it is shown in FIG. 5. The valve body 12, 13 of each valve 10, 11 is preferably in this or any other embodiment as described herein arranged within the fresh air flow drainage path 7, respectively within the exhaust air flow drainage path 8, between the valve seat 14, 15 of the corresponding valve 10, 11 and the common drainage outlet 9.

Both fresh air flow drainage path 7 and the exhaust air flow drainage path 8 are fluidic connected to common drainage outlet 9. The common drainage outlet 9 as well as fresh air flow drainage path 7 and exhaust air flow drainage path 8 may be comprised by, respectively defined and/or delimited by, a drainage assembly housing 22. The whole unit shown in FIG. 3 to 6 may be referred to as a drainage assembly. Drainage assembly housing 22 defines fresh air flow drainage path inlet 23 which may in this or any other embodiment described herein provide a fluidic connection to unit compartment 3, particularly to fresh air flow path 4. Accordingly, drainage assembly housing 22 further defines exhaust air flow drainage path inlet 23 which may in this or any other embodiment described herein provide a fluidic connection to unit compartment 3, particularly to exhaust air flow path 5. Therefore, no matter in which air flow path, i.e. in exhaust air flow path 5 or in fresh air flow path 4, undesired liquid accumulation occurs, this liquid can flow in the corresponding air flow drainage path 7 or 8 and from there to common drainage outlet 9 via valve 10 or 11, from which it can be expelled from the unit.

Each one of the two valves 10 and 11 is configured such that the corresponding valve body 12, 13 is maintained in the closed position shown in FIG. 5 in its corresponding valve seat (i.e. valve body 12 in valve seat 14 and valve body 13 in valve seat 15) at least partially, or generally also completely, due to the negative pressure provided by the ventilation assembly 6 inside unit compartment 3. In the embodiment shown in FIG. 5, this is achieved by arranging the valve seat 14 (in the following reference is made to the elements of the exhaust air flow drainage path, but it is clear that this also applies to the elements of the fresh air flow drainage path) between valve body 13 and the unit compartment 3, respectively exhaust air flow drainage path inlet 24 which provides a fluidic connection to unit compartment 3. If a negative pressure is applied to unit compartment 3, valve body 13 is pulled, respectively sucked downwards onto valve seat 15 in parallel to the gravitational force and thus maintained in this closed position. This is indicated by the force vector of maintaining force F_{M} which is the sum of the gravitational force which acts in the direction of the F_{M} and by the force F_{P} acting on the valve body due to the negative pressure.

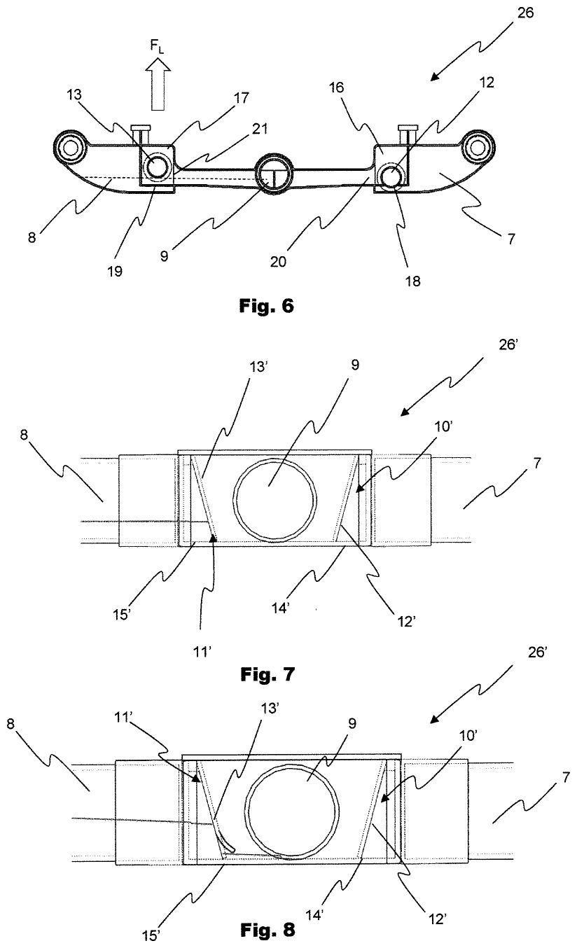

If undesired fluid accumulates and flows via exhaust air flow drainage path inlet 24 into exhaust air flow drainage path 8, it is blocked from flowing to common drainage outlet 9 by valve 11 as valve body 13 is in the closed position (see FIG. 5). However, at some point, the pressure, respectively the liquid force (indicated by F_{L} in FIG. 6) exerted by the liquid on valve body 13 exceeds the maintaining force, i.e. the force which maintains valve body 13 in its valve seat 15. When this threshold is reached, the liquid moves valve body 13 away from valve seat 15, i.e. the valve body is switched into an open position as shown in FIG. 6, thereby enabling the flow of liquid through valve 11 to common drainage outlet 9. The liquid in FIG. 6 is indicated by the dotted line. As soon as a certain amount of liquid has flown through valve 11, the liquid force falls again below the threshold, i.e. it falls below the maintaining force valve body 13 returns to the closed position in which it undergoes generally a liquid tight connection with its valve seat 15.

In the embodiment shown in FIGS. 3 to 6, the valves 10 and 11 are ball valves. This means, valve bodies 12 and 13 are valve balls. Preferably, in this or any other embodiments as described herein, valve seat 14 and 15 of such a ball valve may have the shape of a truncated cone, wherein the larger diameter opening faces the valve body.

Each valve 10 and 11 comprises further a ball accommodation chamber 16 and 17 (see FIG. 6) within which the corresponding valve bodies 12 and 13 are arranged and which each is configured to maintain its valve body inside the ball accommodation chamber. Furthermore, each accommodation chamber 16 and 17 is configured such that its corresponding valve ball can move inside it in such a way that it can be switched between the open position and the closed position. Typically, in this or any other embodiment, each of the ball accommodation chambers 16 and 17 may at least partially or fully be defined by chamber walls.

Each one of the two ball accommodation chambers 16 and 17 comprises a chamber fluid inlet 18, 19, which is defined by the corresponding valve seat. This means, this chamber fluid inlet is closed if the valve body is in the closed position. Furthermore, each one of the two ball accommodation chambers 16 and 17 comprises a chamber fluid outlet 20, 21, through which liquid may flow from the ball accommodation chamber 16, 17 towards common drainage outlet 9. In this or any other embodiment as described herein, the chamber fluid inlets 18, 19 and the chamber fluid outlets are smaller than the corresponding valve bodies 12 and 13, in other words, they prevent the valve body from passing them. The chamber fluid inlet is arranged such that liquid flowing through the ball accommodation chamber coming from the unit compartment enters the ball accommodation chamber via the chamber fluid inlet. Furthermore, the chamber fluid outlet is arranged such that liquid flowing through the ball accommodation chamber coming from the unit compartment exits the ball accommodation chamber via the chamber fluid outlet and flows from there to the common drainage outlet 9.

Each ball accommodation chamber may in this or any other embodiment as described herein, be arranged between the common drainage outlet and the exhaust air flow drainage path inlet 23, respectively the fresh air flow drainage path inlet 22.

FIG. 7 shows another embodiment of a part of a heat recovery ventilation unit, e.g. a drainage assembly 26′ as it can be used in a heat recovery ventilation unit according to the invention. In contrast to the embodiment shown in FIGS. 3-6, drainage assembly 26′ does not comprise two ball valves, but two flap valves 10′ and 11′. Again, flap valve 10′ is arranged within, respectively comprised by, fresh air flow drainage path 7 and flap valve 11′ is arranged within, respectively comprised by, exhaust air flow drainage path 8. Both, fresh air flow drainage path 7 and exhaust air flow drainage path 8 are fluidic connected, i.e. if the valves are in the open position, to common drainage outlet 9. In these embodiments, the two valves are flap valves comprising as valve body 12′, 13′ a flap which is configured to undergo a liquid tight sealing with its corresponding valve seat 14′, 15′. In the embodiment shown, liquid (indicated by the horizontal line) has accumulated inside exhaust air flow drainage path 8. Also in this embodiment, both valves 10′ and 11′ are configured such that its corresponding valve body 12′, 13′ is maintained in its closed position in the corresponding valve seat 14′, 15′ at least partially by the negative pressure provided by the ventilation assembly within unit compartment 3 (not shown, cf. FIG. 2). However, after a certain amount or volume of liquid has accumulated in front of valve body 13′, i.e. the flap, the maintaining force originating from the negative pressure provided by the ventilation assembly and optionally additionally from the gravitational force, is exceeded by the liquid force being exerted by the liquid within exhaust air flow drainage path 8 and the flap is pivoted into an open position such that the liquid can flow through the valve to common drainage outlet 9 where it is expelled from the unit.

FIG. 8 shows an embodiment being related to the embodiment of FIG. 7. However, in this case, as can be seen from the figure, the open position of valve body 13′, i.e. the flap is not achieved by pivoting the whole flap, but by pivoting only a portion of the flap, i.e. the lower portion with respect to the valve seat and the remaining part of the flap which remains in its position.

1. A heat recovery ventilation unit (1) comprising:
a. a unit housing (2) defining a unit compartment (3);
b. a fresh air flow path (4) and an exhaust air flow path (5) in heat exchange contact to each other;
c. a ventilation assembly (6) configured for providing a negative pressure within the unit compartment (3);
d. a fresh air flow drainage path (7) configured for collecting and discharging liquid from the fresh air flow path (4) and an exhaust air flow drainage path (8) configured for collecting and discharging liquid from the exhaust air flow path (5), wherein the fresh air flow drainage path (7) and the exhaust air flow drainage path (8) are fluidic connected to a common drainage outlet (9); wherein each of the fresh air flow drainage path (7) and the exhaust air flow drainage path (8) comprises a valve (10, 10′, 11, 11′) having a valve body (12, 12′, 13, 13′) and a valve seat (14, 14′,15, 15′), wherein each valve (10, 10′, 11, 11′) is configured such that the valve body (12, 12′, 13, 13′) is maintained in a closed position in the valve seat (14, 14′, 15, 15′) at least partially due to the negative pressure provided by the ventilation assembly (6).

2. The heat recovery ventilation unit (1) according to claim 1, wherein each valve (10, 10′, 11, 11′) is configured such that the valve body (12, 12′, 13, 13′) is further maintained in the closed position in the valve seat (14, 14′, 15, 15′) by the gravitational force.

3. The heat recovery ventilation unit (1) according to claim 1, wherein each valve (10, 10′, 11, 11′) is configured such that the valve body (12, 12′, 13, 13′) is switched from the closed position into an open position if a liquid force exerted by a liquid within the fresh air flow drainage path (7) or the exhaust air flow drainage path (8) onto the valve body (12, 12′, 13, 13′) exceeds a maintaining force originating from the negative pressure provided by the ventilation assembly (6) and optionally additionally from gravitational force.

4. The heat recovery ventilation unit (1) according to claim 3, wherein each valve (10, 10′, 11, 11′), and each valve body (12, 12′, 13, 13′), is configured such that the valve body (12, 12′, 13, 13′) is switched from the open position into the closed position if the liquid force exerted by liquid within the fresh air flow drainage path (7) or the exhaust air flow drainage path (8) onto the valve body (12, 12′, 13, 13′) falls below the maintaining force originating from the negative pressure provided by the ventilation assembly (6) and optionally additionally from the gravitational force.

5. The heat recovery ventilation unit (1) according to claim 1, wherein each valve (10, 11) is a ball valve wherein the valve body (12, 13) is a valve ball.

6. The heat recovery ventilation unit (1) according to claim 5, wherein each valve (10, 11) comprises a ball accommodation chamber (16, 17) configured such that the valve ball is maintained within the ball accommodation chamber (16, 17) and such that the valve ball can be moved inside the ball accommodation chamber (16, 17) such that the valve (10, 11) can be switched between the open position and the closed position.

7. The heat recovery ventilation unit (1) according to claim 6, wherein each ball accommodation chamber (16, 17) has a volume which is at least 1.2-times larger than a volume of the valve ball.

8. The heat recovery ventilation unit (1) according to claim 6, wherein each ball accommodation chamber (16, 17) comprises a chamber fluid inlet (18, 19) defined by the valve seat (14, 15) and a chamber fluid outlet (20, 21), wherein at least one of the chamber fluid inlet (18, 19) and the chamber fluid outlet (20, 21) is fluidic closed in the closed position and both the chamber fluid inlet (18, 19) and the chamber fluid outlet (20, 21) are fluidic open in the open position.

9. The heat recovery ventilation unit (1) according to claim 1, wherein each valve (10′, 11′) is a flap valve wherein the valve body (12′, 13′) is a flap.

10. The heat recovery ventilation unit (1) according to claim 9, wherein the flap valve is configured such that it can be switched from the closed position into the open position either by pivoting the whole flap with respect to the valve seat (14′, 15′) or by bending or pivoting only a portion of the flap with respect to the valve seat (14′, 15′) and/or with respect to the remaining part of the flap.

11. The heat recovery ventilation unit (1) according to claim 1, wherein the fresh air flow drainage path (7) and the exhaust air flow drainage path (8) are symmetric to each other, in particular, with respect to a symmetry plane.

12. The heat recovery ventilation unit (1) according to claim 1, further comprising a drainage assembly housing (22), wherein the drainage assembly housing (22) defines the fresh air flow drainage path (7), the exhaust air flow drainage path (8) and the common drainage outlet (9).

13. The heat recovery ventilation unit according to claim 12, wherein the drainage assembly housing (22) is injection molded.

14. The heat recovery ventilation unit according to claim 12, wherein the drainage assembly housing (22) defines a fresh air flow drainage path inlet (23) and an exhaust air flow drainage path inlet (24), which are both offset with respect to the common drainage outlet (9).

15. The heat recovery ventilation unit (1) according to claim 1, wherein the valve body (12, 12′, 13, 13′) and/or the valve seat (14, 14′, 15, 15′) are made of at least one of a polymer material and an elastomer.

16. Use of a heat recovery ventilation unit (1) according to claim 1 in a building, for ventilating the building.
